(19) United States
(12) Patent Application Publication
(10) Pub. No.: US 2009/0244692 A1
(43) Pub. Date: Oct. 1, 2009

(54) VARIABLE FOCUS LENS TO ISOLATE OR TRAP SMALL PARTICULATE MATTER

(75) Inventors: Emile Johannes Karel Verstegen, Eindhoven (NL); Simone Irene Elisabeth Vulto, Eindhoven (NL); Dirkjan Bernhard Van Dam, Eindhoven (NL); Thomas Jan De Hoog, Eindhoven (NL); Judith Margreet Rensen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINIKLIJKE PHILIPS ELECTRONICS N.V., Eindhoven (NL)

(21) Appl. No.: 12/303,429

(22) PCT Filed: May 10, 2007
(86) PCT No.: PCT/IB2007/051771

§ 371 Date: Dec. 4, 2008

(30) Foreign Application Priority Data
Jun. 6, 2006 (EP) 06115018.1

(51) Int. Cl. G02F 1/29; G02B 3/12; G02B 27/10

(52) U.S. Cl. 359/315; 359/665; 359/620

(57) ABSTRACT

Beam manipulation member for use in an optical tweezers system, the beam manipulation member comprising at least one optical element, being controllably deformable in order to act on a laser beam in response to signals coming from the optical tweezers system. The beam manipulation member may be used to change the focal distance of the optical tweezers system and also to deflect the laser beam.

### FIELD OF THE INVENTION

The present invention relates to an optical tweezers system and a method for operating such a system. In particular, the present invention is directed to a beam manipulation member with a deformable optical element comprised in an optical tweezers system.

### BACKGROUND OF THE INVENTION

Applications of optical tweezers are found for example in biology, physics, nanofabrication, and as optical actuators for miniaturized machines.

The principle of optical tweezers is based on the exploitation of the forces of radiation pressure. A strongly focused laser beam is capable of catching and holding particles (of dielectric material) in a size range from nm to μm. This technique makes it possible to study and manipulate particles like atoms, molecules (even large) and small dielectric spheres. Basic properties of optical tweezers are that a particle becomes trapped in a light intensity distribution. The light exerts a force on the particle in a gradient intensity distribution towards the point where the intensity reaches its maximum. As a result, for instance a particle can be trapped in the focal point of an optical beam. Changing the position of the focal point also changes the position of the particle in space. Mechanical means using a motor or piezo actuator for displacing the lens or tilting a mirror are known. A drawback of these mechanical means is that they are complicated and require mechanically moveable parts that are susceptible to wear. Furthermore, each additional degree of freedom normally requires a dedicated actuator and possibly also an additional optical element such as a lens or a mirror. Accordingly, an exemplary optical tweezers system having three translational and one rotational degrees of freedom becomes complicated and rather expensive.

### SUMMARY OF THE INVENTION

It is an object of the invention to provide an alternative to mechanical means for manipulation of a laser beam in an optical tweezers.

In accordance with one aspect of the invention, there is provided a beam manipulation member for use in an optical tweezers system, the beam manipulation member comprising at least one optical element, being controllably deformable in order to act on a beam in response to signals coming from the optical tweezers system.

The beam manipulation member of this aspect of the present invention provides for beam control in an optical tweezers system. It has the capability of assuming the functionality of substantially mechanical beam manipulation means currently used in optical tweezers systems. At the same time, the beam manipulation member of the present invention is less susceptible to the above-mentioned drawbacks of mechanical means. It may even be exempt from one or more drawbacks due to its different configuration, such as for example mechanical tolerances. The beam is for example a laser beam employed in an optical tweezers system to trap particles, bacteria or other. Due to the deformability of the optical element, beam manipulation may be more flexible than in previous arrangements. It also offers the opportunity to reduce the number of optical elements in the path of the beam. Several functions that up to now each required a distinct optical element may be consolidated.

Beam manipulation is to be understood as an action on the beam by which one or more of the beam's properties can be changed when passing through the beam manipulation member. In particular, the beam's geometric properties are subject to be changed by the beam manipulation member, such as the beam direction, its convergence, the shape of its cross section, to name a few.

The optical element represents the component that directly acts on the beam. It may be a refractive optical element or a reflective optical element. The optical element may also present a diffracting effect. The optical element is deformable so that the internal spatial material distribution of the optical element can be changed. Optical effects such as refraction or reflection typically occur at locations where the propagation medium changes, either abruptly or gradually. Thus, changing the material distribution of the optical element changes the optical behavior of the optical element. An advantage of the employed optical element is that its material distribution is controllable. By driving the beam manipulation member and the comprised optical element with appropriate signals, the optical element is deformed which in turn changes the optical behavior of the beam manipulation member. In other words, the beam manipulation member realizes a mapping of the drive signal(s) to its optical behavior. The drive signals for the beam manipulation member come from the optical tweezers system. Thus, the optical tweezers system is provided control over the beam manipulation action. In this context, it is to be noted that also a seemingly independent controller generating the drive signals shall understood as being a part of the optical tweezers system. The reason is that controlling the position of e.g. a particle is a fundamental function of an optical tweezers system.

In accordance with another aspect of the present invention, the beam manipulation member further comprises a chamber containing a first medium, a second medium, an interface between the first medium and the second medium, and interface control means, wherein one of the first medium and the second medium acts as said optical element.

The chamber typically has a constant volume. Also the volumes of the first medium and the second medium are typically constant. The first and the second medium are for example two immiscible fluids having different optical properties. If both fluids have about the same density, then the gravity has no substantial influence on the operation of the beam manipulation member. An interface exists between the two mediums, the shape of which depends on several factors, such as the surface tension, the wettability, or a capillary effect of each of the two mediums. It is advantageous that the interface can be influenced by means of interface control means, resulting in e.g. a modified shape, position, or orientation of the interface.

In accordance with another aspect of the present invention, the interface is delimited by one or more edge segments, and the interface control means are arranged to individually act on said edge elements.

In the case of the interface being delimited by a single edge segment, the interface is acted upon in a uniform manner from all sides. An example for such an arrangement with a single edge segment is a circular interface or an elliptical interface. When there is only a single edge, a substantially symmetric deformation of the optical element with respect to a center of gravity of the latter can be expected. In the more general case of a plurality of edge segments, each of which being individually controllable by the interface control means, a more flexible configuration of the interface can be obtained. In particular, also asymmetrical shapes of the interface are possible. The concept of symmetry may either refer to rotational symmetry (for example with respect to the optical axis of the optical element when at rest), or to mirror symmetry depending on the interface shape. The ability to control edge segments individually gives additional degrees of freedom in the plane perpendicular to the resting state optical axis of the optical element.

According to another aspect of the present invention, the beam manipulation member comprises an electro-wetting lens and the interface control means comprises electrodes arranged to supply an individual voltage to each of the edge segments.

An electro-wetting lens exploits the fact that a conductive fluid and a non-conducting fluid react differently when exposed to an electric field. Especially the surfaces that are in contact with the walls of the chamber tend to react to an applied electric field, because of a modified wettability of the chamber wall surfaces. The required electric field is produced by the electrodes that are part of the interface control means. Besides the one or more electrodes corresponding to the one or more edge segments, a ground electrode is provided as a common electric ground. This ground electrode may have the same distance to each of the edge segment electrodes. It may even be in contact with the conducting fluid. In the case of several electrodes each having a different potential, the resulting electric field presents transitions between the electrodes. Typically, smooth transitions between the different edge segments are desired. This can be achieved by keeping the electrodes small and providing an electrically resistive path between two neighbor electrodes. Depending on the resistance of this path, a current will flow from one electrode to the other which causes a voltage drop along the path. If a smooth transition is not desired in order to obtain special interface shapes, the electrodes are placed substantially adjacent one to the other with only a small insulation between them to avoid leak currents and sparkovers.

According to another aspect of the present application, the optical element presents an optical axis and is deformable asymmetrically with respect to the optical axis, and the interface control means are arranged to act asymmetrically on the edge segments in a time-varying manner.

An advantage of the optical element being asymmetrically deformable with respect to the optical axis is that in this manner the beam may be changed in its cross sectional shape. If the beam is focused, the asymmetrical deformation of the optical element also results in an asymmetrical focal spot. In combination with a time-varying action of the interface control means on the edge segments, the asymmetrical focal spot can be rotated about the beam axis. A particle trapped at the focal spot of the beam experiences a torque on account of the asymmetrical focal spot rotating about the beam axis. Therefore, an advantage is that a particle can be brought into rotation by the laser beam. To this end, the edge segment electrodes may be actuated in a circular pattern. This effect is difficult to accomplish by means of all-mechanical beam manipulation means, because a special lens, such as an anamorphic lens (different lens curvatures along the two principal axis directions), must be rotated about its optical axis by means of an electro motor, for example. The optical axis of the optical element is defined for the situation in which the optical element is at rest, that is none of the electrodes applying an electrical field. Indeed, the actual optical axis of the optical element may be variable. Furthermore, the optical axis of the optical element may present a bend, indicating that the beam's propagation direction is changed by the optical element.

According to another aspect of the present invention, the interface control means are arranged to act on the interface in a periodic time pattern.

An advantage of providing a periodic time pattern is that, in combination with applying a torque to the particle by rotating an asymmetrical focal spot of the laser beam, the torque can be supplied in a permanent manner. This can be exploited to operate miniaturized rotational machines, such as pumps, valves, centrifuges and the like in a variety of applications. A periodic time pattern also allows for an oscillating movement of the focal spot of the laser beam. It is also possible to take a sample, such as a particle, bacterium etc., on a roundtrip including several sites. At each site, the sample undergoes a specific test, for example testing its the sample's reaction to certain substances. The ability of an optical tweezers system to measure forces in the nano-Newton and μ-Newton range may be used to measure attraction forces between the sample and a given substance. The beam manipulation member of the present invention may be used to pick up a sample at a first location on a sample carrier, transport it to a plurality of test sites, and finally transport it to a drop off location. Thereafter, the focal spot returns to the first location. Grabbing and releasing the sample may be accomplished by shortly switching off and on the laser beam. Other alternatives may be envisioned, such as displacing the focal spot beneath the sample carrier, causing the sample to come to rest on the sample carrier.

According to another embodiment of the present invention, a beam manipulation member for use in an optical tweezers system comprises at least one optical element comprising material having a controllable refractive index.

In this manner, optical properties of the beam manipulation member may be modified by changing the refractive index of a material that is a contained within the optical element. Since a number of the optical properties of an optical element depend on the refractive index of the material that substantially forms the optical element, those optical properties may be influenced by adjusting or changing the refractive index. The optical properties may be for example the focal length of a lens, the angle of deflection of a prism, or the like. No moving parts are necessary for changing the refractive index of the material so that a high switching velocity is possible. Most of the properties and advantages recited for the beam manipulation member having a controllably deformable optical element are also valid for the beam manipulation member featuring material having a controllable refractive index.

According to a related embodiment of the present invention, the material is a liquid crystal material. A liquid crystal contains liquid crystalline molecules that alter their optical properties in the presence or absence of an electric field. In order to form the lens with the desired optical properties, the liquid crystal molecules need to be directed in a specific orientation. Well-known materials to induce this orientation are polyimides. International application publications WO 2004/059350 and WO 2005/076069 describe a component comprising liquid crystal and possible applications. Accordingly, a lens that forms the optical element or a part thereof may comprise two transparent substrates that have concave surfaces provided with respective transparent electrode and orientation layers. The concave surfaces define a cell volume that is filled with liquid crystal molecules which have a negative anisotropy of index of refraction. The liquid crystal thus has an elliptic index of refraction that satisfies the following conditions: nₑ<nₒₓ, nₑ<n_{oz}, where nₑ is an index of refraction of an extraordinary ray, nₒₓ is an index of refraction of an ordinary ray polarized in the X-direction, and n_{oz} is an index of refraction of an ordinary ray polarized in the Z-direction. For most liquid crystals, the index of refraction actually satisfies the following condition as well: nₒₓ=n_{oz}=nₒ, where nₒ is a polarization independent index of refraction of an ordinary ray. The orientation films may be arranged so that the liquid crystal molecules are oriented in parallel with the respective orientation film. However, when an AC or DC voltage is provided between the two electrodes, the orientation of liquid crystal molecules can be tilted 90° and an effective index of refraction n_{eff} relative to light impinging the lens is then lowered in accordance with the following equation: n_{eff}=(nₑ+nₒ)/2. Due to this reduction of the index of refraction, the refracting power of the optical element diminishes and the lens thereby increases its focal length. Moreover, by controlling the voltage using a variable resistor, the focal length can be continuously varied. In effect, the lens exhibits a variable focal length.

According to a related embodiment of the present invention, the liquid crystal material is birefringent and the optical element comprises electrodes. Birefringence denotes the presence of different refractive indices for the two polarization components of a beam of light. Birefringent materials have an extraordinary refractive index (nₑ) and an ordinary refractive index (nₒ), with the difference between the refractive indices being Δn=nₑ−nₒ. In other words, a birefringent lens discriminates itself from a standard lens in that it has two focal points, each of these focal points selectable by the polarization direction of the light. The continuous switching principle of a LC-lens is based on modulation of the refractive index of the liquid crystal medium by reorientation of the liquid crystal molecules induced by an electric field. Birefringence may be exploited in polarization sensitive lenses (PS-lenses). PS-lenses may be used to provide different focal points for a single or different wavelength(s) by ensuring that the same or different wavelengths are incident upon the lens with different polarizations.

According to a further embodiment, the optical element comprises two segments of layers of liquid crystal material and corresponding electrodes. The two segments are stacked perpendicular to each other. In this manner, the beam manipulation member is made insensitive to the polarization direction. This can be achieved in particular by using directors that are perpendicularly stacked. In this situation, unpolarized light can be used since all polarization components of the light are subsequently influenced by a difference in refractive index between the liquid crystal and the isotropic medium.

In a further embodiment, the electrodes are controllable in an individual manner. Especially in an embodiment that comprises a number of electrodes arranged for example at the perimeter of the liquid crystal material, a different refractive index for different regions of the liquid crystal material may be achieved. This may be exploited in order to obtain an asymmetric lens. Applications for an asymmetric lens are described above for the case of a controllably deformable optical element.

In a further embodiment, the electrodes are controllable in a time-varying manner and/or periodic manner. This may be used to move a particle trapped by the optical tweezers system. Another application is to exert a torque on the particle in order to cause a rotation of the particle. Again, further applications and characteristics of electrodes that are controllable in a time-varying manner are also described above in the context of a beam manipulation member comprising a controllably deformable optical element.

The beam manipulation member comprising a controllably deformable optical element and the beam manipulation member comprising an optical element having a controllable refractive index have in common that they do not require mechanical actuators. They may therefore be commonly regarded as beam manipulation members having means for controllable redirection of light rays. In the special case of refractive elements, they may also be commonly regarded as beam manipulation members comprising optical elements having controllable refractive power.

According to one aspect of the present invention, an optical tweezers system comprises a beam manipulation member as described above.

The optical tweezers systems benefits from the beam manipulation member's ability to change the direction and the focal distance of the laser beam without a need for mechanical elements. The beam manipulation member may perform all the basic beam control functions required in an optical tweezers system. Among these basic functions are adjusting the focal distance and moving the focal spot in the x-y-plane, which is the plane substantially perpendicular to the optical axis an objective of the optical tweezers system. Nevertheless, certain functions may still be performed by mechanical elements. Furthermore, it may be contemplated to use two or more beam manipulation members according to the present invention, each assuming a particular function. A possible separation of functions may be that one beam manipulation member provides a focal distance adjustment, a second beam manipulation member assumes deflection in the x-y-plane, and a third beam manipulation member assumes the function of rendering the focal spot asymmetrical and rotating it in time. Another advantage of the proposed optical tweezers system is that the beam manipulation members or less susceptible to wear than known mechanical systems.

According to one aspect of the present invention, a method of manipulating a laser beam of an optical tweezers system, the optical tweezers system comprising a controllably deformable optical element, comprises a the steps of:

receiving a setpoint signal for manipulation of the laser beam;

calculating at least one drive signal for said optical element by means of a function mapping the setpoint to the drive signal; and

driving the optical element with the signal coming from the optical tweezers system.

An advantage of the proposed method is that it allows controlling the controllably deformable optical element. Such control may be provided in an open loop (i.e. no feedback) or a closed loop (i.e. with feedback). In most cases, a setpoint signal corresponds to a parameter of the laser beam that a user wishes to realize (e.g. direction of the laser beam, focal distance of the laser beam, symmetry/asymmetry of the laser beam). The deformable optical element is one of the components that are used to translate the setpoint signal into a corresponding effect. As such, the optical element has a given transfer function, mapping an input signal to an output effect. In this example, the setpoint signal (or a signal derived from the setpoint signal) serves as an input for the deformable optical element. The input for the optical element may also be regarded as the optical element's drive signal. The output effect of the optical element may be regarded as the action on a laser beam passing through the optical element. The relation between input and output is often described by means of a transfer function. This transfer function defines the dependency of the output on the input, for example. If a certain output is desired, the transfer function may be resolved for the input in order to find the corresponding input. The calculated input is then used as the driving signal for the optical element. Since the deformable optical element is hardly subject to wear, the transfer function remains substantially constant over the lifetime of the optical element. Furthermore, the deformable optical element typically presents improved tolerances compared to its mechanical counterparts. Since tolerances are difficult to deal with in a transfer function and the resolution thereof, the transfer function of the deformable optical element may be less complicated and easier to resolve than those of mechanically controlled optical elements or arrangements.

In a further aspect of the present invention, the setpoint defines a localization of a focal spot of the laser beam. The function comprises a mapping of the drive signal to at least one parameter defining a deformation of the controllably deformable optical element, a mapping of the deformation to at least one optical characteristic of the optical element, and a mapping of the optical characteristic to at least one parameter of the laser beam.

The optical element may be modeled as a system comprising a number of subsystems. A first subsystem describes how the drive signal influences the deformation of the optical element. The behavior of this subsystem depends on the type of drive signal and the exploited physical effect. For example, the drive signal may be an input voltage and the subsystem's output the radii of curvature of a meniscus in a lens based on the electro-wetting principle. A second subsystem describes the relation between the deformation and optical characteristics of the optical element. An example of an optical characteristic of the optical element is the focal length of a lens. A third subsystem describes the relation between the optical characteristics of the optical element and at least one parameter of the laser beam. Examples of laser beam parameters are for example the angle of beam spread or its propagation direction.

In another aspect of the present invention, a method of manipulating a laser beam of an optical tweezers system comprises an optical element comprising a material having a controllable refractive index, the method comprising the steps of:

receiving a setpoint signal for a manipulation of the laser beam;

calculating at least one drive signal for the optical element by means of a function mapping the setpoint to the drive signal;

driving the optical element with the signal coming from the optical tweezers system.

An advantage of the proposed method is that it allows controlling the optical element comprising a material having a controllable refractive index. Such control may be provided in an open loop (i.e. no feedback) or a closed loop (i.e. with feedback). In most cases, a setpoint signal corresponds to a parameter of the laser beam that a user wishes to realize (e.g. direction of the laser beam, focal distance of the laser beam, symmetry/asymmetry of the laser beam). The optical element is one of the components that are used to translate the setpoint signal into a corresponding effect. As such, the optical element has a given transfer function, mapping an input signal to an output effect. In this example, the setpoint signal (or a signal derived from the setpoint signal) serves as an input for the optical element. The input for the optical element may also be regarded as the optical element's drive signal. The output effect of the optical element may be regarded as the action on a laser beam passing through the optical element. The relation between input and output is often described by means of a transfer function. This transfer function defines the dependency of the output on the input, for example. If a certain output is desired, the transfer function may be resolved for the input in order to find the corresponding input. The calculated input is then used as the driving signal for the optical element. Since the optical element is hardly subject to wear, the transfer function remains substantially constant over the lifetime of the optical element. Furthermore, the optical element typically presents improved tolerances compared to its mechanical counterparts. Since tolerances are difficult to deal with in a transfer function and the resolution thereof, the transfer function of the deformable optical element may be less complicated and easier to resolve than those of mechanically controlled optical elements or arrangements.

In a further aspect of the present invention, the setpoint defines a localization of a focal spot of the laser beam, wherein the function comprises a mapping of the signal to at least one parameter defining a value of refractive index of the material, a mapping of the refractive index to at least one optical characteristic of the optical element, and a mapping of the optical characteristic to at least one parameter of the laser beam.

The optical element may be modeled as a system comprising a number of subsystems. A first subsystem describes how the drive signal influences the refractive index of the material within the optical element. The behavior of this subsystem depends on the type of drive signal and the exploited physical effect. For example, the drive signal may be an input voltage and the subsystem's output the refractive index of the material within the optical element. A second subsystem describes the relation between the refractive index and optical characteristics of the optical element. An example of an optical characteristic of the optical element is the focal length of a lens. A third subsystem describes the relation between the optical characteristics of the optical element and at least one parameter of the laser beam.

Examples of laser beam parameters are for example the angle of beam spread or its propagation direction.

An optical tweezers system benefits from employing a controllably deformable optical element as a part of the beam manipulation assembly. The same results can be expected as with conventional, mechanically displaced or oriented elements. Drawbacks of these conventional mechanical components are circumvented. Furthermore, the deformable optical element offers a greater flexibility for the beam manipulation.

### BRIEF DESCRIPTION OF THE DRAWINGS

These and other aspects of the invention will be apparent from and elucidated with reference to the embodiments described hereinafter.

FIG. 1 is a diagrammatic view of an optical tweezers system according to the prior art.

FIG. 2 is a diagrammatic view of an optical tweezers system according to one embodiment of the present invention.

FIG. 3 is a longitudinal section of an optical element in a resting state.

FIG. 4 shows the optical element of FIG. 3 in a symmetric excitation state.

FIG. 5 shows the optical element of FIG. 3 in an asymmetric excitation state.

FIG. 6 is a longitudinal section of a microscope objective equipped with the optical element as of FIGS. 3 to 5.

FIG. 7 is a diagrammatic perspective view of the frontlens of a microscope objective used in an optical tweezers system.

FIG. 8 is a diagrammatic top view of the microscope frontlens according to the arrow VIII in FIG. 7.

FIG. 9 shows an exemplary electrode disposition of a beam manipulation member from above.

FIG. 10 is a representation of electrode voltages over time of the electrodes depicted in FIG. 9.

FIG. 11 is a schematic representation of a liquid crystal lens in a first state.

FIG. 12 is a schematic representation of a liquid crystal lens in a second state.

The figures are not drawn to scale and identical reference numerals in different Figures refer to corresponding elements.

### DETAILED DESCRIPTION

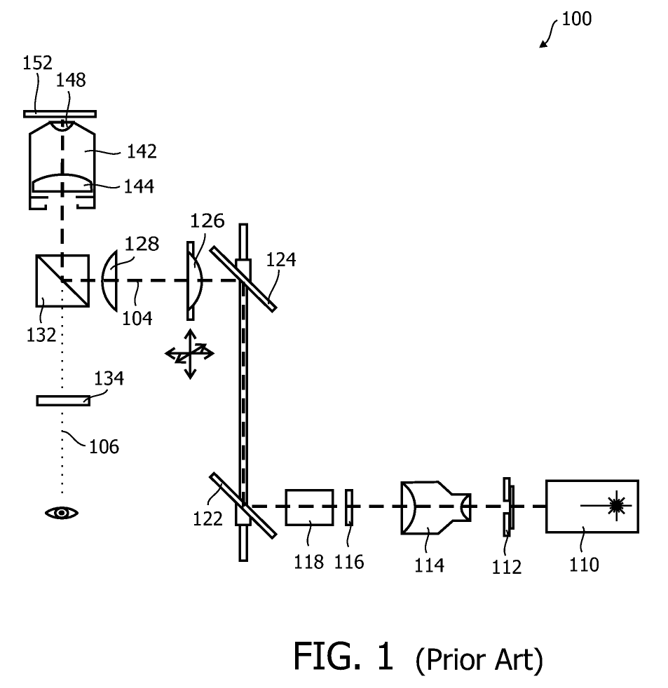

FIG. 1 shows a prior art optical tweezers system as a bloc diagram. Optical tweezers are used to manipulate particles with light-induced pressure. The underlying principles are for example described in “Optical trapping and manipulation of viruses and bacteria” by A. Ashkin and J M Dziedzic, Science 1987; 2335:1517-20. Depending on whether the diameter of the particle is smaller or larger than the wavelength of the used light, an electric dipole approximation or a ray optics approach is used to analyze the interaction of light with particles. When light is scattered by an object, there is a scattering force which tends to push objects along the direction of light propagation. This is called the scattering force acting on the object. In addition, a so-called gradient force acts on the object, as well. This gradient force has two major effects. The first is that the object is pulled towards the center of the beam, where the light intensity is higher than in the outer region of the laser beam. The other effect occurs when the beam is strongly focused. This leads to a strong light intensity gradient towards the focal point. The light exerts a force on the particle in the gradient intensity distribution towards the point where the intensity reaches its maximum. As a result the object becomes trapped in the focal point of an optical beam. In an optical tweezers system, the focal point may be moved around in three dimensions, i.e. along the propagation direction of the laser beam and in the two directions perpendicular to the propagation direction.

To this end, a known optical tweezers system comprises the following components. The optical tweezers system 100 presents a laser beam path 104 and an observation light path 106. A laser source 110 produces a laser beam which passes a shutter 112 for conveniently switching on and off the laser beam. A beam expander 114 provides a defined beam diameter. In the depicted optical tweezers system, a variable attenuator for bright and polarized laser light comprises a rotatable halfwave plate 116 and a fixed prism polarizer 118. A beam steerer consists of two movable mirrors 122 and 124, both mounted on a same vertical post. Note that mirror 122 and also the light path back to the laser source is actually perpendicular to mirror 124 about the vertical axis. For convenience, it is drawn here in the same plane.

Further down the path of the laser beam, a simple 1:1 telescope arrangement that is used to steer and parfocalize the laser spot comprises a fixed lens 128 and a moveable lens 126. These two identical planconvex lenses 126 and 128 are placed the sum of their focal lengths apart, so that parallel light entering moveable lens 126 from will produce parallel light emerging from fixed lens 128 of the same beam diameter. The moveable lens 126 is mounted on an x-y-z translation stage or micromanipulator. Movements of this lens in all three directions approximately generate corresponding movements of the laser focal spot in the same three dimensions. For a movement of the focal spot in the axial direction (z-direction), lens 126 is pushed towards lens 128. This causes the laser beam to become slightly divergent when leaving the second lens 128. This pushes the focal spot away from the objective and deeper into the specimen. Likewise, as lens 126 is pulled away from lens 128, the laser beam leaving the telescope to the left of lens 128 becomes somewhat convergent, bringing the focus towards the objective. Movement of lens 126 in the x-y plane, perpendicular to the optical axis, produces a deflection in the light leaving the lens 128, which is basically a rotation of the beam. If lens 128 is imaged into the back of the objective pupil, then this rotation occurs in a conjugate plane to the objective pupil, resulting in a translation of the laser spot. Lens 128 accomplishes this by virtue of its location at a distance 2f behind the objective pupil, where f is the focal length of lenses 126 and 128.

A dichroic mirror 132 reflects the appropriate laser wavelength, usually ˜1100 nm or ˜850 nm. The dichroic mirror 132 transmits visible light below 650 nm. This directs the laser beam towards a microscope objective 142. Since visible light may pass the dichroic mirror, the scene may be observed via observation path 106 using standard microscope components. As an additional safety measure, an infrared blocking filter 134 is provided between dichroic mirror 132 and an observer.

The standard microscope objective 142 accomplishes the major amount of focusing the laser beam. The objective is typically a high NA objective, having a magnification between 40× and 100×, a NA between 1.25 and 1.40, and being designed for oil- or water immersion. The microscope objective comprises a rear focus lens 144 and a front lens 148. The objective may contain aberration correction means that are not depicted for sake of simplicity.

The objects to be trapped are disposed on a sample carrier 152.

In case the object is to be rotated around the laser beam axis, optical tweezers system 100 requires further means, such as an anamorphic lens and a motor or equivalent to rotate the anamorphic lens at the desired rotation speed. The anamorphic lens produces an asymmetric focal spot. Rotating the lens also rotates the focal spot, and thus the object. An alternative is to use a special grating, a so-called helical phase profile, which converts a TEM₀₀ laser beam (the fundamental mode of wave propagation for a laser beam) in a helical mode. However, this method has the drawback that the rotation speed cannot be easily changed.

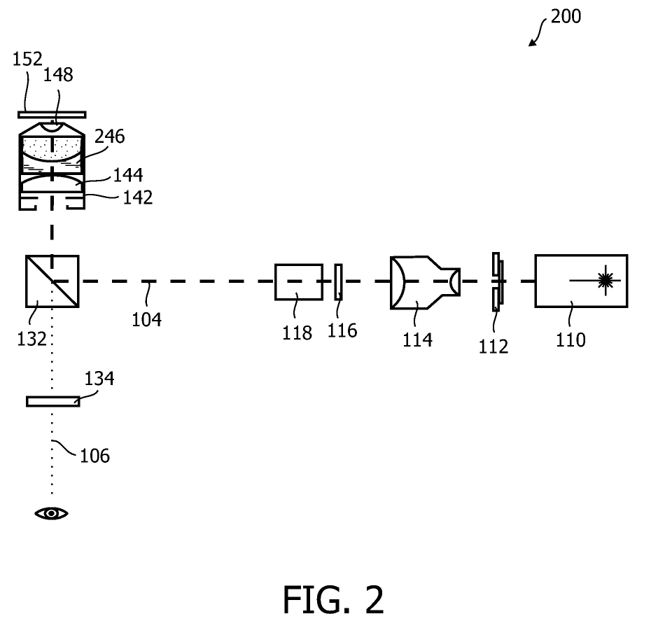

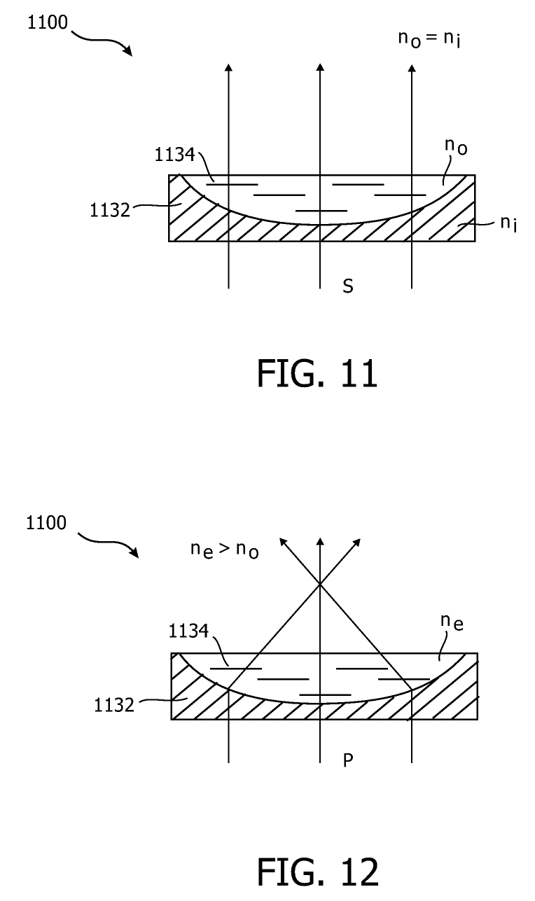

FIG. 2 shows an optical tweezers system according to one embodiment of the present invention. This system differs from the optical tweezers system of FIG. 1 in that no telescope arrangement is employed for controlling the focal spot of the laser beam. This function is now assumed by a beam manipulation member 246 located, in this embodiment, in microscope objective 142. More particularly, beam manipulation member is located between the back focal lens 144 and the front lens 148 of the microscope objective. In a different embodiment the beam manipulating member may be placed in front of the microscope objective 142. The beam manipulation member 246 may be a variable focus lens exploiting the electrowetting effect. In this case, it contains two immiscible fluids having different refractive indices. The meniscus between the two fluids may be changed so that a varying optical behavior of the lens may be obtained in response to commands given to the beam manipulation member. Another option is to use an optical element comprising material having a controllable refractive index as depicted in FIGS. 11 and 12. This material may be a liquid crystal material and may further be birefringent. In known optical tweezers systems as depicted in FIG. 1, the telescope part required a significant amount of space. As mentioned above, mechanical actuators with their known drawbacks were needed in order to control the moveable lens 126 shown in FIG. 1.

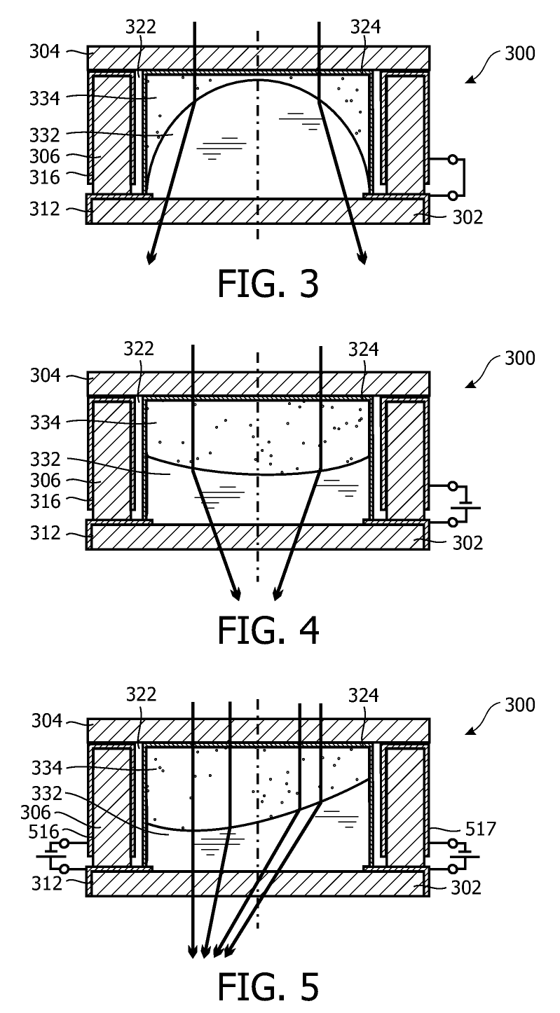

FIG. 3 shows a section in an axial plane of an electrowetting lens 300. The electrowetting lens 300 is shown in a resting state. In the depicted form, it has a substantially cylindrical form. The electrowetting lens comprises a sealed container having a container base 302, a container lid 304, and a container wall 306. The container is preferable made of a transparent material. However, the container wall does not necessarily be transparent.

The electrowetting lens also comprises a base electrode 312 and a wall electrode 316. The base electrode 312 is formed as a ring with an outer rim. It is located at the transition between the container base 302 and the container wall 306. Furthermore, the base electrode 312 extends from the exterior to the interior of the container by means of appropriate passages between the container base 302 and the container wall 306. To the right of the base electrode 302 is depicted a connecting terminal through which a voltage is impressed on the base electrode. The wall electrode 316 surrounds container wall 306 with the exception of a portion adjacent to the container base 302. Here, the wall electrode 316 is represented as two concentric cylinders that are connected by a ring at their respective upper edges. Notwithstanding, for example the outer cylinder could be dispensed with, if a satisfactory even voltage distribution across the entire electrode can be achieved even for fast changing voltages. A connecting terminal is represented at the right side of the wall electrode 316 in the vicinity of the connecting terminal for the base electrode 312.

An insulator 322 is located in the opening defined by the interior cylinder of wall electrode 316. Furthermore, a hydrophobic coating 324 is provided lining the interior of the container at the top and the side of the cavity, but not at the bottom.

The cavity formed by the container, the electrodes, the insulator and the hydrophobic coating is filled with two immiscible fluids. The first fluid 332 is electrically conducting and may be for example salted water. The second fluid is insulating and may be for example some kind of oil. The water-based first fluid typically has a refractive index of about 1.33, while the refractive index of the second fluid can be chosen as high as 1.6 by employing appropriate oil. The bigger the difference of the refractive indexes, the more efficient the resulting electrowetting lens is. By matching the density of both fluids, the lens becomes stable against shocks and vibrations. It also becomes independent from the orientation in which it is used. Since the first fluid consists mainly of water, the hydrophobic coating 324 on the interior top and side walls of the cavity acts on the first fluid by repelling it. As a result, the first fluid tends to minimize its contact surface with the hydrophobic coating 324. This behavior results in a curved interface between the two fluids. The interface is also called meniscus and acts as a spherical lens. Since the oil 334 has a higher refractive index than the water solution 332, the optical effect of the electrowetting lens is comparable to a divergent lens, as can be seen from the diverging rays of light passing the lens from top to bottom.

FIG. 4 shows the same electrowetting lens as depicted in FIG. 3, this time with a voltage different from zero applied to the connecting terminals of base electrode 312 and wall electrode 316. Under the application of this voltage charges accumulate in the wall electrode whereas opposite charges are induced in the conducting fluid near the solid/liquid interface. The amount of charge, which is related to the applied voltage, results in an additional force acting on the meniscus between the two fluids. Because the amount of liquid remains the same, this additional force results in a change in radius of curvature of the interface between the two fluids. Since the interface is now shaped in a convex manner with respect to the second fluid 334, the electrowetting lens behaves like a plan convex lens. A converging lens is a converging lens and its effect on rays of light passing through the electrowetting lens is represented in FIG. 4.

FIG. 5 shows a similar electrowetting lens as FIGS. 3 and 4. The difference is that the electrowetting lens 500 shown in FIG. 5 has an electrode disposition that is not fully rotational symmetrical. In fact, wall electrode now comprises two distinct electrodes 516 and 517. Therefore, different voltages can be impressed on two opposing sides of the electrowetting lens. This results in the interface being pulled up the hydrophobic coating 324 to different heights on each of the sides. In turn, this causes the interface to be tilted with respect to a plane that is perpendicular to the optical axis of the electrowetting lens. As long as the meniscus is flat, the electrowetting lens behaves like a prism. To this end, the mean voltage applied to electrodes 516 and 517 should be somewhere in between 0 volts and the voltage applied to the electrowetting lens shown in FIG. 4. The tilting of the meniscus can be combined with a divergent behavior as in FIG. 3, or a convergent behavior as in FIG. 4. In FIG. 5, a combination of tilting the meniscus to the left and shaping it in a convex manner with respect to the second fluid 334 is shown. This results in the electrowetting lens presenting a focal spot which is situated below the lens and slightly to the left.

In FIG. 5 there are shown two wall electrode segments 516 and 517. Obviously, any number of electrode segments can be chosen for a higher freedom in directing light passing through the electrowetting lens in directions that differ from the optical axis. For a more complete description it is referred to international patent application publication WO 2004/051323.

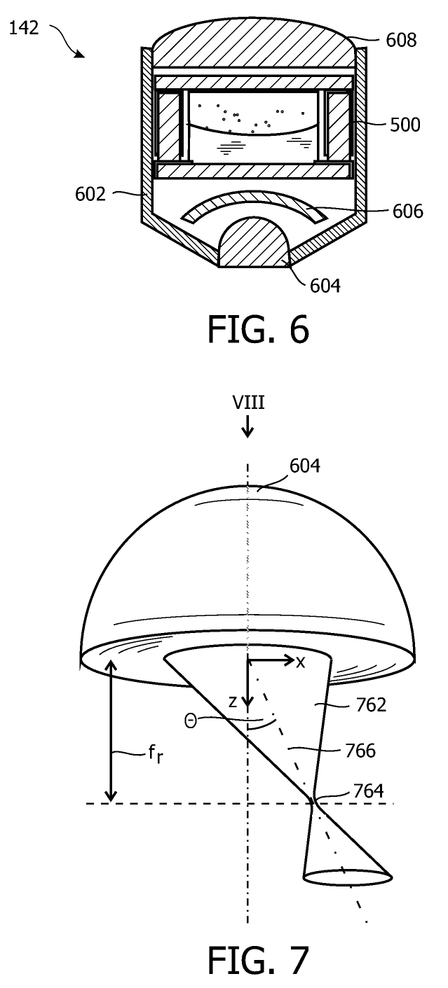

FIG. 6 shows a section in an axial plane through a microscope objective 142 equipped with an electrowetting lens 500. In a known manner, a microscope objective comprises a front lens 604, a meniscus lens 606, and for example a back focal length lens 608 (also called rear focal lens). The term meniscus lens should not be confused with the meniscus of the electrowetting lens 500. The microscope objective also comprises a housing 602 that serves to hold the lenses and to provide a protection against incident light from the sides, as well as dust. The microscope objective 142 is to be understood as a simplified representation. Additional components may provided, such as aberration and chroma correction means. Furthermore, microscope objective 142 is not drawn to scale. The electrowetting lens 500 is placed between the meniscus lens 606 and the back focal length lens 608. In this location the electrowetting lens 500 can fulfill focusing and directing the laser beam of the optical tweezers system in a convient manner. The front lens 604 of the objective provides for a major part of the focusing power needed for an optical tweezers system. By changing the focal length of the electrowetting lens, the focal distance of the combined system can be changed. This results in the focal spot to be moved up or down.

It should be noted that the view field for the observer is also changed as the electrowetting lens changes its focal distance and deflection direction. A user who is familiar with state of the art optical tweezers systems might need some time to familiarize with this mode of operation. However, it should be appreciated that the focal spot will always be in the center of the observer's view field. As an orientation for the observer, the sample carrier 152 from FIGS. 1 and 2 may show a grid and corresponding markings.

In the alternative, an electrowetting lens could be located at a point, at which the laser beam path 104 and the normal microscope light path 106 (FIG. 2) are separated. The electrowetting lens would then be located in the laser beam path 104.

Furthermore, it is also possible to provide two or more electrowetting lenses. One of the electrowetting lenses would then be used to adjust the focal length of the optical tweezers system, while one or more other electrowetting lenses provide the beam deflection.

FIG. 7 is a schematic view of the front lens 604 of a microscope objective 142 in a perspective slightly from below, illustrating some geometrical variables of the optical tweezers system. Front lens 604 is traversed by a laser beam 762 in direction substantially from top to bottom. FIG. 7 shows a special case, in which the laser beam is centered in the plane of the lower surface of the front lens. In general, depending on the setting of the F-stop, the laser beam does not need to be centered with respect to the mentioned surface. In FIG. 7, before entering the front lens 604, laser beam 762 was deflected by means of an electrowetting lens, for example. Accordingly, the laser beam 762 does not hit the upper hemisphere of the front lens 604 in a direction parallel to the optical axis of the front lens. A coordinate system is defined, the origin of which is located in the center of the lower plan surface of the front lens 604. The z-axis of the coordinate system extends along the optical axis of the front lens 604 in the propagation direction of the laser beam, i.e. downwards in FIG. 7. The x-y-plane of the coordinate system is defined by said lower plan surface of the front lens 604. Only, the x-axis is shown. It may be advantageous to calibrate the angular position of the microscope objective around its optical axis before using the optical tweezers system, in order to be able to control a desired beam deflection in a defined manner.

The laser beam 762 presents a laser beam axis 766. The angle between the optical axis of the front lens and the laser beam axis is denoted by Θ (capital THETA). The laser beam 762 is focused to a focal spot 764. The z-coordinate of the focal spot is given by the resulting focus length of the optical tweezers system fᵣ. The focal spot of a lens displaces in a plane perpendicular to the optical axis, if the direction of the incident light changes.

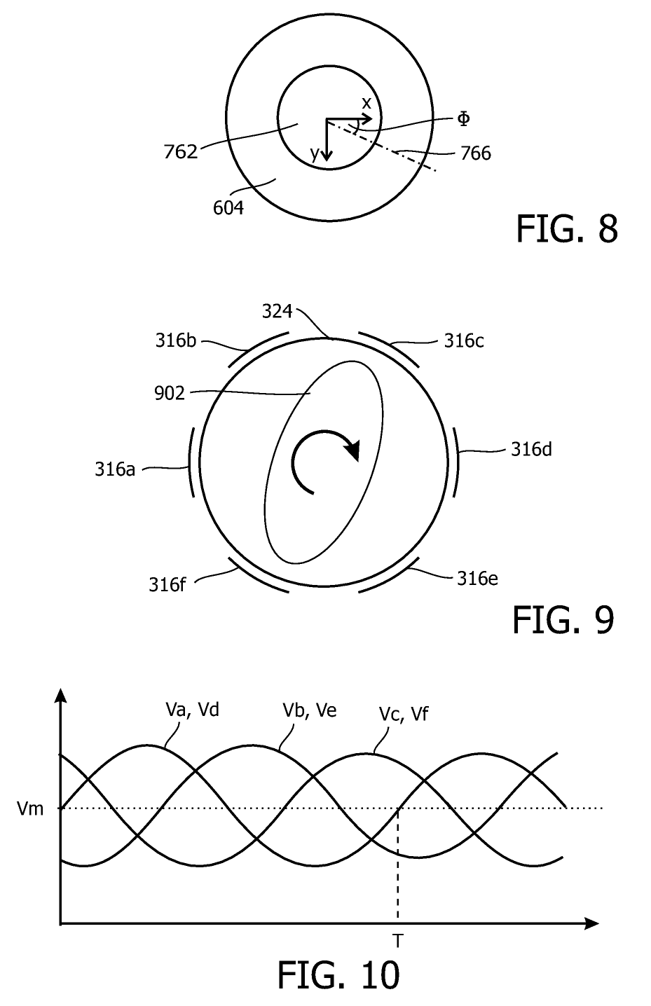

FIG. 8 shows a view from above on the front lens 604 in the direction VIII of FIG. 7. The x-axis and the y-axis of the coordinate system is shown. The inner circle represents the outline of the laser beam 762 at the lower plan surface of front lens 604. The laser beam axis 766 is shown under an angle Φ (capital PHI) to the x-axis.

One of the ways to determine the x-coordinate and the y-coordinate of the focal spot computationally is to calculate the intersection point of laser beam axis 766 with the focal plane. Since the z-coordinate is already known as the resulting focal length fᵣ, only the x-coordinate and the y-coordinate need to be determined. Under normal circumstances, the x-, y-, and z-coordinates are pre-selected and it is up to the optical tweezers system to direct the focal spot to this position. Accordingly, the inverse calculations have to be performed in order to arrive at the corresponding values for fᵣ, Φ (PHI), and Θ (THETA). The appropriate electrode signals may then be calculated from these values. Use of one or several look-up tables would also be an option.

FIG. 9 is a schematic representation of an electrowetting lens viewed from the top. For the sake of simplicity, only the hydrophobic coating 324 and six electrodes 316a-316f are shown. Reference numeral 902 represents for example a contour line of the meniscus between the first and the second fluid 332, 334. It may be for example the contour line defining the median z-position between the uppermost and lowermost z-positions of the current meniscus shape. As can be seen, the contour line 902 has the shape of an ellipse. This means that the meniscus presents different radii of curvature along the two main axes of the ellipse. Where the ellipse is elongated, the radius of curvature is relatively high, and vice versa. By driving the electrodes 316a-316f with a special pattern, it is possible to rotate the ellipse over time. FIG. 9 represents a moment for a currently plan convex lens with respect to the second, higher refractive fluid 334, at which electrodes 316c and 316f are driven with smaller voltages compared to the other electrodes 316a, 316b, 316d, and 316e. In fact, an interfacial wave is created along the meniscus. As a result to this, the focal spot become asymmetric and rotates in time. Another way to look at it is to regard the electrowetting lens as an anamorphic lens. In order to produce an asymmetry that is able to rotate a particle held by the optical tweezers system, it may already suffice to exploit an aberration effect such as coma aberration produced by the electrowetting lens.

FIG. 10 represents the signal developments for the six electrodes 316a-316f in FIG. 9. If a symmetrical configuration of the meniscus is desired, the voltages Va through Vf are grouped by pairs. The two voltages belonging to the same pair, for example Va and Vd, have the same value for a symmetrical configuration of the meniscus. In FIG. 10, the voltages are represented as sine functions having a period T. This is not required so that the voltages may obey other functions. The voltages have a mean value Vm. This mean value defines the desired direct voltage component which is needed to provide a certain curvature and, in turn, a certain focal length. As mentioned above, already aberration such as coma aberration may suffice for providing the required asymmetry. Therefore, also a weak alternating voltage component may already provide the desired effect.

FIG. 11 shows a schematic representation of a liquid crystal lens 1100 in a first state of operation. Nowadays it is possible to fabricate birefringent structures based on liquid crystals. An example of a component manufactured according to this method is a birefringent lens as described in WO 2004/059350. The lens comprises an isotropic shape 1132 and an anisotropic shape 1134. Isotropic shape 1132 presents a refractive index nᵢ. The refractive index of the anisotropic shape in this state of operation is n₀ and is generally higher than the refractive index of the isotropic shape. Thus, a lens function is generated. FIG. 11 shows a special case in which both refractive indexes are equal so that n₀=nᵢ. A birefringent lens discriminates itself from a standard lens in that it has two focal points, each of these focal points selectable by the polarization direction of the light. S-polarized light S will observe a refractive index n₀ matched to the refractive index nᵢ of the isotropic shape.

FIG. 12 shows the liquid crystal lens in a second state of operation. In this case, p-polarized light p hits the lens and anisotropic shape 1134 presents a refractive index nₑ that is higher than n₀, nₑ>n₀. The switching principle of the lens 1100 is continuous. This is based on the modulation of the refractive index of the liquid crystal medium of the anisotropic shape 1134 by the reorientation of the liquid crystal molecules induced by an electric field.

These lenses can also be made insensitive to the polarization direction. To this end, a second segment containing another switchable liquid crystal layer may be used. This second switchable liquid crystal layer comprises directors that are perpendicularly stacked. In this situation unpolarized light can be used since all polarization components of the light are subsequently influenced by a difference in refractive index between the liquid crystal and the isotropic medium.

Although one of the systems described herein is based on electrowetting, the same principle also applies for a system based on magnetowetting, hence a system which contains two fluids, one of which is a ferrofluid, and where the shape of the meniscus is changed by a magnetic field. A detailed discussion can be found in European patent application no. EP 04102437.

1. Beam manipulation member for use in an optical tweezers system, the beam manipulation member comprising at least one optical element, being controllably deformable in order to act on a laser beam in response to signals coming from the optical tweezers system.

2. Beam manipulation member according to claim 1, further comprising a chamber containing a first medium, a second medium, an interface between said first medium and said second medium, and interface control means, wherein one of said first medium and said second medium acts as said optical element.

3. Beam manipulation member according to claim 2, wherein said interface is delimited by one or more edge segments, and wherein said interface control means are arranged to individually act on said edge segments.

4. Beam manipulation member according to claim 3, wherein said beam manipulation member comprises an electro-wetting lens and said interface control means comprises electrodes arranged to supply an individual voltage to each of said edge segments.

5. Beam manipulation member according to claim 3, wherein said optical element presents an optical axis and is deformable asymmetrically with respect to said optical axis, and wherein said interface control means are arranged to act asymmetrically on said edge segments in a time-varying manner.

6. Beam manipulation member according to claim 5, wherein said interface control means are arranged to act on said interface in a periodic time pattern.

7. Beam manipulation member for use in an optical tweezers system, the beam manipulation member comprising at least one optical element comprising material having a controllable refractive index.

8. Beam manipulation member according to claim 7, wherein said material is a liquid crystal material.

9. Beam manipulation member according to claim 8, wherein said liquid crystal material is birefringent and wherein said optical element comprises electrodes.

10. Beam manipulation member according to claim 9, said optical element comprising two segments of layers of liquid crystal material and corresponding electrodes, said segments being stacked perpendicular to each other.

11. Beam manipulation member according to claim 10, wherein said electrodes are controllable in a time-varying and/or periodic manner.

12. Optical tweezers system, comprising a beam manipulation member according to claim 1.

13. Method of manipulating a laser beam of an optical tweezers system comprising a controllably deformable optical element, the method comprising the steps of:
receiving a setpoint signal for a manipulation of said laser beam;
calculating at least one drive signal for said optical element by means of a function mapping said setpoint to said drive signal; and
driving said optical element with said signal coming from the optical tweezers system.

14. Method according to claim 13, wherein
said setpoint defines a localization of a focal spot of said laser beam, wherein said function comprises
a mapping of said drive signal to at least one parameter defining a deformation of said controllably deformable optical element,
a mapping of said deformation to at least one optical characteristic of said optical element, and
a mapping of said optical characteristic to at least one parameter of said laser beam.

15. Method of manipulating a laser beam of an optical tweezers system comprising an optical element comprising a material having a controllable refractive index, the method comprising the steps of:
receiving a setpoint signal for a manipulation of said laser beam;
calculating at least one drive signal for said optical element by means of a function mapping said setpoint to said drive signal; and
driving said optical element with said signal coming from the optical tweezers system.

16. Method according to claim 15, wherein
said setpoint defines a localization of a focal spot of said laser beam, wherein said function comprises
a mapping of said drive signal to at least one parameter defining a value of refractive index of said material,
a mapping of said refractive index to at least one optical characteristic of said optical element, and
a mapping of said optical characteristic to at least one parameter of said laser beam.
